(19) United States
(12) Patent Application Publication
(10) Pub. No.: US 2008/0069935 A1
(43) Pub. Date: Mar. 20, 2008

(54) COHESIVE NON-FREE FLOWING SWEETENER COMPOSITIONS INCLUDING LOW-DENSITY INGREDIENTS

(76) Inventors: Renny Ison, Great Kingshill (GB); Melanie Loades, West Byfleet (GB); Gareth Williams, Reading (GB)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/532,698

(22) Filed: Sep. 18, 2006

(51) Int. Cl. A23L 1/236; A23L 1/0534; A23L 1/09; A23L 1/305; A23L 1/221; A23L 1/222

(52) U.S. Cl. 426/548; 426/615; 426/650; 426/655; 426/656; 426/658; 426/661

(57) ABSTRACT

Cohesive non-free flowing sweetener compositions, e.g., sweetener cubes, useful for adding sweetness to liquid foodstuffs, for example, beverages, having a reduced caloric burden as compared to conventional sucrose cubes, are provided. More particularly, a cohesive non-free flowing sweetener composition containing a high intensity sweetener and a low-density bulking agent, wherein a sweetener cube formed from the cohesive non-free flowing sweetener composition having the same dimensions as a conventional sucrose cube has a lower caloric burden and an equivalent sweetness. Methods of making such cohesive non-free flowing sweetener compositions are also provided.

### FIELD OF THE INVENTION

The present invention relates to cohesive non-free flowing sweetener compositions with decreased caloric burden compared to conventional sucrose cubes of similar size and sweetness for delivering sweetness to a liquid foodstuff, for example, a beverage. More particularly, the present invention relates to cohesive non-free flowing sweetener compositions containing a high intensity sweetener and a low-density bulking agent, wherein a sweetener cube formed from the solid, non-free flowing sweetener composition has a lower caloric burden and an equivalent sweetness to a similarly sized sucrose cube. The present invention also provides methods of making and using such cohesive non-free flowing sweetener compositions.

### BACKGROUND OF THE INVENTION

People often add sweeteners to their foods and beverages. For example, sweeteners are added to beverages, such as, coffee and tea. Sweetening a food or beverage alters its flavor and usually increases its appeal. This behavior is found in all cultures, but is especially prevalent in western cultures.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that the same amount of sweetness to be excessive. Moreover, consumers often desire to reduce their caloric intake for health or lifestyle reasons. Therefore, there exists a long-felt need for sweetener products that consumers may use to increase the sweetness of a product at the time of consumption that are consistent with their personal preferences and minimize additional caloric burden.

Methods for sweetening liquid foodstuffs are known. For example, adding sweetener to an unsweetened iced tea beverage will typically involve adding the sweetener to the unsweetened iced tea beverage followed by stirring to disperse the sweetener to create a sweetened iced tea beverage. Such a sweetener is typically in a cube, tablet, granular, powdered, or liquid form.

Sweetening individual servings of a beverage presents a challenge in many food service situations. Frequently, an individual packet of a sweetener is provided along with a serving of a beverage. The packet may contain sucrose, or alternatively may contain high intensity sweeteners such as sucralose, aspartame, or saccharin and a standard bulking agent such as sucrose, glucose or maltodextrin; all of which have a typical calorific value of 4 kilocalories per gram. The user must open the packet and empty the contents into the beverage, and then stir the beverage to obtain dissolution of the sweetener and its complete dispersion in the liquid. The residual packaging of the packet creates waste that may present disposal problems under many situations. Alternatively, sweetener may be provided in the form of single serve cohesive non-free flowing sweetener composition, which contains approximately one (or more) sucrose equivalent teaspoon(s) of sweetness (one sucrose equivalent teaspoon being about 4 to about 5 grams per teaspoon of sucrose). Typically, such sweetener cubes do not require individual packaging, and therefore, reduce the steps involved in sweetening the beverage and the waste associated with the sweetener.

Sweetener cubes are cohesive non-free flowing compositions that include bulking agents. Bulking agents are typically crystalline carbohydrates, such as, sucrose, which are also available in combination with high intensity sweeteners. More recently a number of lower caloric burden bulking agents have entered the market. Some of these lower caloric burden bulking agents have physical and sensory characteristics similar to sucrose, and others have only a few physical or sensory characteristics similar to sucrose and/or some undesirable characteristics.

The availability of high intensity sweeteners provide the ability to lower the caloric burden involved with sweetening a liquid foodstuff, e.g., individual servings of beverages. For example, sucralose is about 500 to about 600 times as sweet as sucrose (a.k.a. table sugar and cane sugar). One teaspoon of sucrose, which is about 4 to about 5 grams of sucrose, may be replaced by about 6.7 to about 10 milligrams of sucralose. The minute quantities of high intensity sweeteners needed to achieve preferred sweetening of individual servings offer the opportunity to provide new technologies to deliver sweetness to foodstuffs, including individual servings.

In view of the foregoing, there is a need to provide cohesive, non-free flowing sweetener compositions having a lower caloric burden while having similar physical and sensory characteristics to those of a typical sucrose sweetener cube.

### SUMMARY OF THE INVENTION

One embodiment of the present invention is a cohesive non-free flowing sweetener composition comprising, consisting of, and/or consisting essentially of a sweetening amount of a high intensity sweetener and an effective amount of low-density bulking agent, wherein a sweetener cube formed from the cohesive non-free flowing sweetener composition having the same dimensions and an equivalent sweetness of a conventional sucrose cube has a lower caloric burden compared to a conventional sucrose cube.

A further embodiment of the present invention is a cohesive non-free flowing sweetener composition comprising, consisting of and/or consisting essentially of about 0.6% sucralose and about 99.4% agglomerated maltodextrin by weight based on the total weight of the sweetener composition, wherein a sweetener cube formed from the cohesive non-free flowing sweetener composition having the same dimensions and an equivalent sweetness of a conventional sucrose cube has a lower caloric burden compared to a conventional sucrose cube.

Another embodiment of the present invention is a cohesive non-free flowing sweetener composition comprising, consisting of, and/or consisting essentially of about 0.6% sucralose and about 99.4% inulin by weight based on the total weight of the cohesive non-free flowing sweetener composition, wherein a sweetener cube consisting of the cohesive non-free flowing sweetener composition having the same dimensions and an equivalent sweetness of a conventional sucrose cube has a lower caloric burden compared to a conventional sucrose cube.

A further embodiment of the present invention is a cohesive non-free flowing sweetener composition comprising, consisting of, and/or consisting essentially of about 0.4% sucralose and about 99.6% of honeycombed or aerated carbohydrate by weight based on the total weight of the sweetener cube, wherein a sweetener cube having the same dimensions and an equivalent sweetness of a conventional sucrose cube has a lower caloric burden compared to a conventional sucrose cube.

An additional embodiment of the present invention is a cohesive non-free flowing sweetener composition comprising, consisting of, and/or consisting essentially of about 0.4% sucralose and about 99.6% of glassy aerated carbohydrate by weight based on the total weight of the sweetener cube, wherein a sweetener cube having the same dimensions and an equivalent sweetness of a conventional sucrose cube has a lower caloric burden compared to a conventional sucrose cube.

A further embodiment of the present invention is a method for making a cohesive non-free flowing sweetener composition comprising, consisting of, and/or consisting essentially of combining a high intensity sweetener with a low-density bulking agent to form a blend; adding sufficient water to the blend; forming the blend into a shape; and drying the shape.

### BRIEF DESCRIPTION OF THE DRAWINGS

FIG. 1 shows the effect on the caloric burden of a sweetening cube by changing the proportion of various potential low-density bulking agents compared to a sweetener cube made from a reference blend.

FIG. 2 shows the effect on friability over a range of relative humidities of changing the proportion of various potential low-density bulking agents compared to a sweetener cube made from a reference blend.

### DETAILED DESCRIPTION OF THE INVENTION

To reduce the caloric burden of a sucrose cube, the amount of sucrose is decreased, which results a smaller cube size. The sweetness lost due to the decreased amount of sucrose in the cube can be offset by incorporating high intensity sweeteners, such as, aspartame or acesulfame K into the cube formulation. While such a formulation does reduce the cube's caloric burden, this reduction is limited by the minimum size of the cube that can be manufactured and handled by the consumer. A review of products currently on the market revealed a minimum cube size of about 1.4 grams, which results in a sucrose-containing sweetener cube having about 5.6 kilocalories.

To reduce the caloric burden of a conventional sucrose cube, the sucrose must be replaced partially or in whole by lower calorie components. However, the use of components other than sucrose may present problems with regard to sweetener cube production, storage, and consumer appeal and acceptance. In the present invention, high intensity sweeteners and low-density bulking agents are used to replace sucrose in a cohesive non-free flowing sweetener composition. The use of these components in the cohesive non-free flowing sweetener composition of the present invention produces cohesive non-free flowing sweetener composition having a mass that is less than a conventional sucrose cube having about the same physical dimensions and about the same volume as the cohesive non-free flowing sweetener composition. This lowered mass with unchanged volume (over a conventional sucrose cube) provides a cohesive non-free flowing sweetener composition having a lower caloric burden that may be commercially manufactured and is convenient for the consumer.

As used herein, the term “conventional sucrose cube” means a rectangular prism of cohesive crystalline sucrose having a height, width, and depth from about 5 millimeters to about 20 millimeters. Typically, a conventional sucrose cube is about 15 millimeters on each side and has a caloric burden of about 25 kilocalories. The smallest commercially available and consumer accepted high intensity sweetener/sucrose cubes have two sides that are about 12 millimeters by about 12 millimeters and four sides that are about 9 millimeters by about 12 millimeters and have a caloric burden of about 5.6 kilocalories and weight of about 1.4 grams.

As used herein, all numerical ranges provided are intended to expressly include at least all numbers that fall between the endpoints of ranges.

### High Intensity Sweetener

As used herein, the term “high intensity sweetener” means a substance that provides a high sweetness per unit mass as compared to sucrose and provides little or no nutritive value.

Many high intensity sweeteners are known to those skilled in the art and any can be used in the present invention. Examples of high intensity sweeteners for use in the present invention include aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, thaumatin, salts, derivatives, and combinations thereof. A preferred high intensity sweetener according to the present invention is sucralose.

Cohesive non-free flowing sweetener compositions of the present invention may contain from about 0.01% (wt) to about 3.5% (wt) of a high intensity sweetener. More preferably, cohesive non-free flowing sweetener compositions of the present invention may contain from about 0.05% (wt) to about 2% (wt), even more preferably from about 0.1% (wt) to about 1% (wt) of a high intensity sweetener based on the weight of the cohesive non-free flowing sweetener composition.

If the only high intensity sweetener used is sucralose, the cohesive non-free flowing sweetener compositions of the present invention preferably contain from about 0.1% (wt) to about 0.6% (wt) of sucralose. More preferably, such a cohesive non-free flowing sweetener composition of the present invention contains from about 0.2% (wt) to about 0.5% (wt), even more preferably from about 0.4% (wt) to about 0.5% (wt) of sucralose based on the weight of the cohesive non-free flowing sweetener composition.

### Bulking Agents

The specific bulking agent(s) are selected to produce sweetener cubes from the cohesive non-free flowing sweetener composition with physical and sensory characteristics similar to those of a sucrose cube. Such sweetener cubes may contain specific bulking agents that have physical and sensory properties similar to sucrose or may contain a combination of bulking agents that individually do not, but when combined do, have characteristics similar to sucrose. Numerous factors must be considered in the selection of bulking agents for use in the present invention.

First, the bulking agent generally has a sweetness intensity well below that of sucrose, so the addition of a high intensity sweetener is required to produce a sweetener cube from the cohesive non-free flowing sweetener composition that has a level of sweetness acceptable to consumers. The amount of high intensity sweetener used in such a sweetener cube is inversely related to the native sweetness of the bulking agent. Care must be taken to properly balance the ingredients to produce the sweetness expected by the consumer that is approximately equal to the sweetness of a sucrose-containing sweetener cube, e.g., one teaspoon of sucrose.

As used herein, the term “teaspoon” refers to a standard teaspoon, which has a volume of about 5 milliliters. Accordingly, a teaspoon of sucrose has a mass of about 4 to about 5 grams.

Second, bulking agent(s) must be selected that are acceptable to consumers in roughly five areas: appearance, taste, side effects, use, and cost. With regard to appearance, the sweetener cubes from the cohesive non-free flowing sweetener composition should mirror its sucrose equivalent as much as possible. The sweetener cube should appear crystalline. And, the sweetener cube should maintain its shape during storage and transport. For example, proteins will often have non-crystalline appearance and some sugars have yellow or sallow color. Neither will produce an acceptable sweetening cube when used in isolation as a bulking agent. Moreover, some possible bulking agents are far too hygroscopic to maintain cube integrity and shape for any length of time when used in isolation. For example, soluble fibers may absorb so much water from the environment that the sweetener cubes will begin to dissolve into a syrup that is undesirable to, and often unusable by consumers.

Low-density bulking agents are particularly useful in the present invention. As used herein, the term “low-density bulking agent” means a food grade substance that has a density less than about 850 grams per liter.

As used herein, a “food grade” material is one that conforms to the standards for foods deemed safe for human consumption set forth in the Codex Alimentarius produced by the World Health Organization (1999).

Examples of low-density bulking agents useful in the present invention include aerated sugars, aerated polyols, aerated complex carbohydrates, agglomerated sugars, agglomerated polyols, and agglomerated complex carbohydrates, maltose, cellulose, inulin, gum arabic, soluble fibers, milk powders, starches, proteins, and combinations thereof. Agglomerated maltodextrin, honeycombed or aerated sugar, and glassy aerated sugar are particularly useful.

Low-density bulking agents may be present in the cohesive non-free flowing sweetener compositions of the present invention in an amount from about 50% (wt) to about 99.7% (wt), more preferably from about 90% (wt) to about 99.7% (wt), and even more preferably from about 99.4% (wt) to about 99.6% (wt), based on the total weight of the cohesive non-free flowing sweetener composition.

Low-density bulking agents may simply be low-density in their conventional form. or may also be produced from standard-density bulking agents by additional processing. Also, using the same processing, the density of an already low-density bulking agent may be further reduced.

For example, an agglomerated product may be produced by fluid bed drying. In this process, the powdered bulking agent is wetted with steam and dried at an elevated temperature (e.g., about 130° C. to about 190° C.). The particles of the bulking agent adhere together in a form, visually similar to a bunch-of-grapes arrangement, incorporating air and decreasing density.

The low-density bulking agent may also be foam spray dried. In this process, a dissolved gas (e.g., carbon dioxide) is introduced into the spray dryer feed. As the feed exits the nozzle of the spray drier, there is a rapid drop in pressure producing an expanded particle foam. The dried foam has a density lower than the powdered bulking agent due to the incorporation of the gas into the foam. The density of the bulking agent may be decreased by up to about 80% in the foam form.

Extrusion technology may also be used to lower the density of a bulking agent. The wet bulking agent is passed through an extruder under pressure. Upon exiting the extruder, there is a rapid pressure drop causing the wet bulking agent to expand and incorporate air. Thus, the extruded bulking agent has a decreased density compared to its original powdered form.

The bulking agent may also be processed into a low density bulking agent with cavitation technology prior to drying. In this process, the wet bulking agent is agitated to introduce bubbles or cavities (cavitation) before drying. Once dried, these bubbles or cavities produce a bulking agent with a decreased density compared to its original powdered form.

Standard-density bulking agents that may be processed into low-density bulking agents include sucrose, glucose, tagatose, maltodextrin, erythritol, and combinations thereof.

In addition to the low-density bulking agents, the sweetener cubes of the present invention may contain a standard-density bulking agent.

As used herein, a “standard-density bulking agent” means a food grade substance that has a density greater than or equal to about 850 grams per liter, which is similar to granulated sugar. Examples of standard-density bulking agents for use in the present invention include mono- and disaccharides, such as, glucose, allose, altrose, mannose, idose, galactose, talose, ribose, arabinose, xylose, lyxose, cellobiose, gentiobiose, isomaltose, lactose, laminarabinose, amylose, mannobiose, xylobiose, sucrose, trehalose, cellobiose, lactulose, fructose, tagatose, lactitol; oligosaccharides and polysaccharides, such as, cyclodextrins, nutriose, maltodextrin; polyols, such as, isomalt, lactitol, maltitol, xylitol, erythritol, mannitol, sorbitol; calcium citrate; and calcium lactate and combinations thereof.

### Producing Cohesive Non-Free Flowing Sweetener Compositions

Shaped cohesive non-free flowing sweetener compositions are generally produced by a process having the following steps: (a) blending the ingredients, (b) forming a shaped composition, and (c) drying the composition. Obviously, each step may have a number of variations.

A further embodiment of the present invention is a method for making a cohesive non-free flowing sweetener composition including the steps of combining a high intensity sweetener with a low-density bulking agent to form a blend, adding water to the blend, forming the blend into a shape, and drying the shape.

While the manner in which the ingredients are blended is not critical, overly aggressive blending may result in an undesirable particle size reduction. It is, however, imperative to have a uniform distribution of the ingredients throughout the blend. Otherwise, both the sweetness and the caloric burden will vary from cube to cube. For ingredients used in small amounts it may be necessary to produce a pre-blend to ensure even distribution. If an ingredient tends to cake or lump, it may need to be passed through a sieve. The most common blenders are those that allow for continuous addition of ingredients.

Forming a shape of the cohesive non-free flowing sweetener composition generally has two phases. First, the blended ingredients are hydrated to a moisture content from about 0.3% to about 3%, usually by the introduction of water or steam. Second, the hydrated ingredients are placed into dyes or molds and compressed to form the desired shape. The hydrated mixture may also be formed into large blocks and later broken into “rough cut” shapes.

Once the hydrated mixture has been formed into the desired shape it is dried. Drying may be accomplished using ovens or, if conditions permit, by exposure to ambient air. The most common dryers are continuous bands passing through a drying tunnel. Drying temperatures and times vary considerably. For example, in ambient air the drying time may be about 24 hours. In contrast, drying in an oven at about 60° C. to about 75° C. can take as little as about 10 to about 20 minutes. A conditioning step may also be required after oven or air-drying of approximately about 12 to about 36 hours to allow moisture to equilibrate throughout the products.

The shape of the mold chosen to form the cohesive non-free flowing sweetener composition determines the overall shape of the cohesive non-free flowing sweetener composition. Any desired shape can be used, including, cube, ball, pyramid, and the like. Additionally, the surface of the cohesive non-free flowing sweetener composition may modified to introduce a feature. A surface feature may be imparted by the surface of the mold used to form the cohesive non-free flowing sweetener composition or the dried cohesive non-free flowing sweetener composition may be further processed to produce the desired surface feature. In addition, the cohesive non-free flowing sweetener composition may also be shaped when still damp to introduce surface features or to produce novel shapes. For example, the dried cohesive non-free flowing sweetener composition may be laser or mechanically etched, or the desired feature may be burned into the surface of the cohesive non-free flowing sweetener composition using a heated tool. Once dry, the cohesive non-free flowing sweetener composition is then packed into tubs, boxes or other food appropriate packaging prior to consumer use.

Another embodiment of the present invention is a sweetener cube formed from a cohesive non-free flowing sweetener composition that is made according to one of the processes described herein.

Cohesive non-free flowing sweetener compositions of the present invention may be of any size convenient for manufacture and acceptable for use by a consumer. Cubes formed of the cohesive non-free flowing sweetener compositions are generally less than about 20 millimeters in height, less than about 20 millimeters in width, and less than about 20 millimeters in depth. Other useful sizes include about 12 millimeters in height, about 12 millimeters in width, and about 9 millimeters in depth, and even more preferably about 9 millimeters in height, about 9 millimeters in width, and about 9 millimeters in depth.

### Consumer Preferences

A conventional sucrose cube is the standard to which all other sweetening cube products are compared. Any sweetening cube product that deviates significantly from the physical and sensory characteristics of a conventional sucrose cube is not likely to be acceptable to the consumer. Table 1 shows physical and sensory characteristics of sucrose cubes and acceptable ranges for other sweetening cube products.

TABLE 1
Physical and sensory characteristics of sucrose cubes and acceptable
ranges for other sweetening cube products.

| Characteristic | Conventional sucrose cube | Acceptable range |
|---|---|---|
| Appearance | White, crystalline | Color from white to pale cream, |
| | | crystalline |
| Taste | Sweet, syrupy | Delivery of sweetness, no other strong |
| | | flavor notes (i.e. any additional flavors |
| | | must not be stronger than the sweetness) |
| Undesirable | None | Minimal negative consumer related |
| effects | | claims such as laxative effect |
| Stability | Maintains shape during | Maintains cube shape during processing |
| | storage and transport | and transport up to 75% RH |
| Solubility | Approx. 30 seconds in hot | Cube dissolves in hot water (150 ml at |
| | water (85° C.) | 85° C.) in about 10 to about 60 seconds |
| | | with agitation |
| Friability | Maintains integrity on | Less than 10% weight loss from dry cube |
| | handling | when agitated for 60 seconds |
| Hardness | 4000 g pressure (bench | 1,000–15,000 g for laboratory made |
| | made), 25,000 machine made | samples, up to 30,000 g for pilot scale/ |
| | (texture analyzer) | commercially made samples |
| Particulate size | 0–2 millimeters | 0–3 millimeters for overall blend of |
| range | | ingredients used to make up the cube |

To be accepted by a consumer as an acceptable substitute for a conventional sucrose cube, a cohesive non-free flowing sweetener composition of the present invention must have enough sensory and physical characteristics within the acceptable ranges shown in Table 1. Every characteristic of the sweetener cube formed from the cohesive non-free flowing sweetener composition need not fall within the ranges in Table 1 for the sweetener cube to be acceptable to a consumer. For example, a sweetener cube of the present invention intended to replace a brown sugar cube would have a brown color, and therefore, would not fall with the acceptable range for “appearance” in Table 1, but would still be acceptable to a consumer.

With regard to taste, a sweetener cube form from a cohesive non-free flowing sweetener composition of the present invention should give a sweetness level equivalent to a similar size sucrose cube, and deliver a sweetness profile similar to sucrose. With regard to side effects, the bulking agent must not produce undesirable or unexpected side effects for the consumer. For example, some sugar alcohols may have a laxative effect on the consumer. Unless this is a desired effect, a cohesive non-free flowing sweetener composition employing such sugar alcohols would not find consumer acceptance.

The cohesive non-free flowing sweetener compositions must also function as expected by the consumer and quickly dissolve to produce the desired sweetness in the foodstuff. For example, the bulking agent may have a low solubility in water, and therefore, the cohesive non-free flowing sweetener composition may dissolve too slowly for the consumer or may not dissolve completely. As noted above, the production of cohesive non-free flowing sweetener compositions with desirable consumer characteristics may be achieved either by the use of a single bulking agent with the desired characteristics or by the use of a combination bulking agents that together produce the desired characteristics.

With regard to cost, the cohesive non-free flowing sweetener compositions should be of acceptable cost to the consumer when compared with other sweetening formats, such as, tablets, sucrose cubes, sucrose, high intensity sweeteners, and granular sweeteners. For example, erythritol may be sourced commercially in a white crystalline format of good particulate size similar to sucrose, but may be comparatively expensive; therefore this may be combined with a less expensive bulking agent such as maltose and still provide the required overall characteristics.

Overlapping with the above considerations are various bulking agent characteristics that affect the production and/or storage and transport of cohesive non-free flowing sweetener compositions. These characteristics include: caloric burden, friability, dissolution, heat of solution, hardness, rigidity, moisture uptake, effect of humidity, and effect of temperature. Processing considerations include ease of raw material storage and processing and ease of flow of mixture for consistent and accurate fill of cube molds. Table 2 lists various ingredients and factors that must be considered in screening for bulking agent(s) useful in the cohesive non-free flowing sweetener compositions of the present invention.

TABLE 2
Potential bulking agents.

| Ingredient | | | | Screening Factors | |
|---|---|---|---|---|---|
| Class | Subclass | Examples | kcal/g | Negatives | Positives |
| Protein | | | 4.0 | Non-crystal appearance | |
| Carbohydrates | Sugars | Sucrose | 4.0 | Consumer negative | |
| | | Fructose | 4.0 | Hygroscopic | |
| | | Lactose | 4.0 | Mostly Small particulates | Low cost |
| | | Galactose | 4.0 | High cost | |
| | | Maltose | 4.0 | | Low cost, Crystalline |
| | | Trehalose | 4.0 | | Excellent appearance |
| | | Tagatose | 1.5 | | Crystalline, Low calorie |
| | Sugar alcohols | Mannitol | 1.6 | Laxative effect | |
| | | Sorbitol | 2.6 | Laxative effect | |
| | | Xylitol | 2.4 | Laxative effect | |
| | | Erythritol | 0.2 | Negative heat of solution | |
| | Complex | Maltodextrin | 4.0 | Non crystalline | Low cost bulking |
| | Carbohydrates | | | | Glue effect |
| | | Polydextrose | 1.0 | Non crystalline | Glue effect |
| | | Soluble Fiber | 1.0–2.0 | Hygroscopic, Laxative | |
| Minerals | | Ca citrate | 2.0 | | Powdery, Possible bulk |
| | | Ca lactate | 2.0 | | Powdery, Possible bulk |

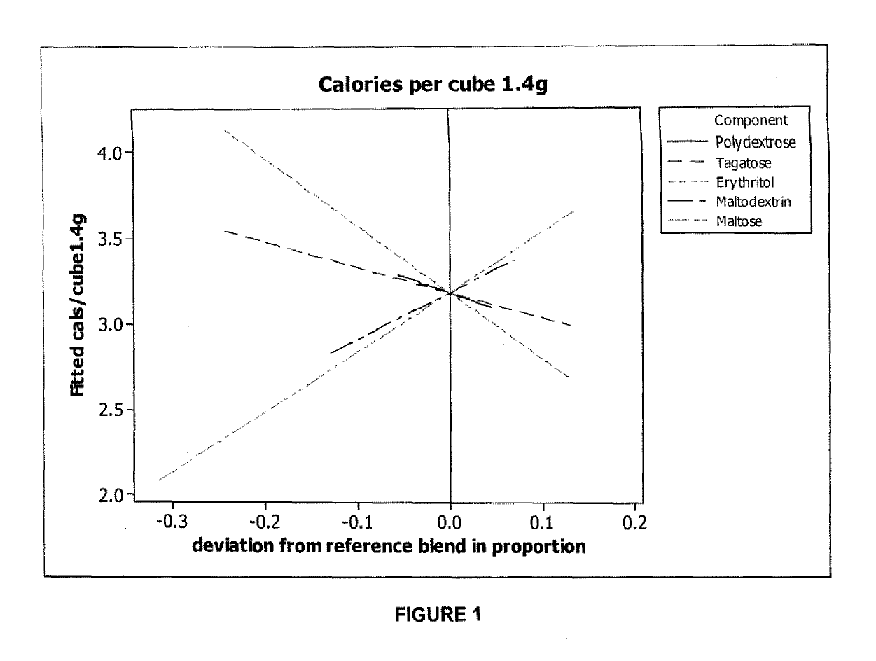

Even if an ingredient is appropriate for use as a bulking agent, the proportion of the ingredient used in the sweetener cube may have significant effects on the characteristics of the cube. For example, FIG. 1 shows the caloric burden as a function of ingredient content for various potential low-density bulking agents. An increase in the maltose or maltodextrin compared to the reference blend increases the caloric burden. In contrast, increases in the proportion of the other ingredients results in a reduction of the caloric burden.

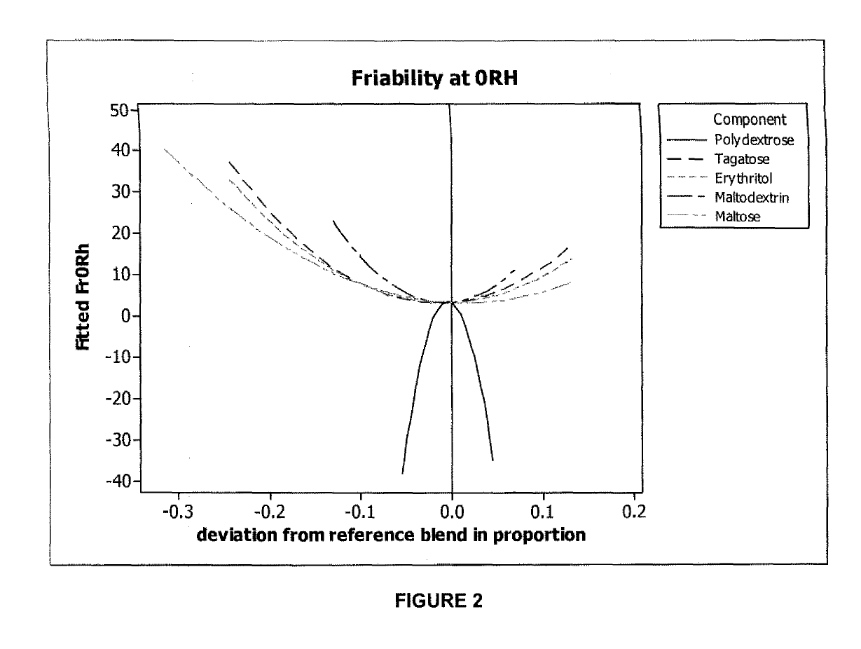

FIG. 2 shows the effect of changing the proportion of various potential low-density bulking agents and polydextrose as compared to a reference blend on friability over a range of relative humidities.

The reference blend is a composition used only as a starting point for measuring the changes in the physical properties of the composition as the proportion of one of the components is varied. The composition of the reference blend for FIGS. 1 and 2 and the variation of the components are shown in Table 3.

TABLE 3
Reference blend and component variation for FIGS. 1 and 2.

| | Reference Blend | Variation |
|---|---|---|
| Component | % (wt) | % (wt) |
| Polydextrose | 9.85 | 0 to 10 |
| Tagatose | 26.6 | 0 to 37.5 |
| Erythritol | 10.85 | 0 to 37.5 |
| Maltodextrin | 7.6 | 0 to 20 |
| Maltose | 44.5 | 0 to 45 |
| Sucralose | 0.6 | None |

Likewise, other ingredient characteristics may be evaluated and the formula may be optimized to produce a sweetener cube with high commercial viability and consumer acceptance.

The following examples are provided to further illustrate the compositions and methods of the present invention. These examples are illustrative only and are not intended to limit the scope of the invention in any way.

### EXAMPLES

### Example 1

The cohesive non-free flowing sweetener compositions of the present invention may be made in any manner known in the art. Described below are two methods for producing cohesive non-free flowing compositions of the present invention: A) a laboratory scale preparation method and B) a larger production scale preparation method.

### A. Laboratory Scale Preparation Method

All ingredients are weighed. The weighed ingredients are placed into a glass jar and blended in a tubular mixer for five minutes. The blended ingredients are then spread as thinly as possible along a flat surface to achieve a layer as close to a one particle thick as possible.

A short burst of water is then sprayed across the layer of blended ingredients with an aerosol pump. The desired amount of water may be measured before addition into the aerosol pump. (For granulated sugar, for example, water added is typically about 3.5 milliliters per 100 grams of sugar.) The blended ingredients are then mixed with a pallet knife.

To determine if enough water has been added, some of the blended ingredients are placed into a cube mold. Using the appropriate stamp, as much of the blended ingredients as possible are compacted into the mold, adding compression on both sides to increase pressure. Once the mold is full the stamp is used to push out the blended ingredients.

If the cohesive non-free flowing composition breaks immediately and granules disperse, there is not enough moisture. The blended ingredients are then spread, sprayed with additional water, and mixed again with the pallet knife. The blended ingredients are then re-evaluated for water content.

On the other hand, if clumps are present and part of the cube remains in the mold, too much moisture has been added to the blended ingredients. In this case, the blended ingredients must be discarded and the process restarted from the beginning.

Once an appropriate amount of water has been added, the blended ingredients are compressed in molds. The molded compositions are then placed onto a tray and dried at 70° C. in an oven. One cube is broken in half about every 10 minutes to assess breakability due to moisture content. Once the water has been removed from the cubes they should be hard throughout. The drying should take about 10 to about 30 minutes. If further drying is desired, the cubes may be placed in a 30° C. room overnight.

### B. Production Scale Preparation Method

All ingredients are weighed and blended to uniformity. The blended ingredients are then transferred to a powder hopper above a cube machine (Type C Cube Machine, Teknikeller, Ankara, Turkey). The blended ingredients are added to the mixing chamber of the cube machine and mixed with water. The amount of water is adjusted to ensure good distribution of water throughout the blended ingredients. Insufficient water will produce deposits of powder on the extraction belt used to transport cubes to the oven and result in friable cubes. Over-wetting the blended ingredients will produce visibly wet cubes, the cubes will be hard, but will have lost the sparkle associated with the glassy surface of individual crystals in conventional sucrose cubes. Target blend moisture content is about 0.5% to about 1.0%, depending on cube appearance.

The wet blended ingredients then fall by gravity from the belt into a rotating mold. Pistons compress the cubes to the required dimensions. The mass of the cubes may be adjusted by tightening the compression plate or by altering the amount of travel of the pistons. The pistons push out the formed cube onto the extraction belt, and a pushing arm pushes the cubes onto a chain conveyor to pass the cubes into the drying oven.

The shape of the mold chosen to form the molded cohesive non-free flowing sweetener composition determines the overall shape of the molded cohesive non-free flowing sweetener composition.

The cubes may then be dried in a static oven or by using a conveying (tunnel) oven. Temperatures should not exceed 70° C. for 10 to 30 minutes. The cubes may need to be “tempered” prior to packing and should cool from the drying temperature to room temperature prior to packing to avoid accumulation of condensation inside the packaging.

As discussed above the cubes may be further processed to introduce a surface feature onto the surface of the cube.

The cohesive non-free flowing sweetener compositions of the following examples may be formed using either of the two methods above.

### Example 2

Cohesive non-free flowing sweetener compositions of the present invention with dimensions of 12 millimeters by 12 millimeters by 10.5 millimeters are made using the method in Example 1.A. containing 0.4% (wt) sucralose, 49.6% (wt) erythritol, 30% (wt) trehalose, and 20% (wt) maltose. The cohesive non-free flowing sweetener compositions have a mass of 1.34 grams. A granulated sugar cube of the same dimensions has a mass of about 1.4 grams.

### Example 3

Cohesive non-free flowing sweetener compositions of the present invention are made using the method of Example 1.A. containing 0.6% (wt) sucralose and 99.4% (wt) agglomerated maltodextrin. The cohesive non-free flowing sweetener composition have a mass of about 0.7 to about 1.29 grams. A granulated sugar cube of the same dimensions has a mass of about 1.4 grams.

### Example 4

Cohesive non-free flowing sweetener compositions of the present invention are made using the method of Example 1.A. containing 0.6% (wt) sucralose and 99.4% (wt) inulin. The cohesive non-free flowing sweetener compositions have a mass of about 0.9 to about 1.3 grams. A granulated sugar cube of the same dimensions has a mass of about 1.4 grams.

### Example 5

Cohesive non-free flowing sweetener compositions of the present invention are made using the method of Example 1.A. containing 0.4% (wt) sucralose and 99.6% (wt) of honeycomb of aerated sucrose. The cohesive non-free flowing sweetener compositions have a mass of about 0.9 to about 1.3 grams. A granulated sugar cube of the same dimensions has a mass of about 1.4 grams.

### Example 6

Cohesive non-free flowing sweetener compositions of the present invention are made using the method of Example 1.A. containing 0.4% (wt) sucralose and 99.6% (wt) of glassy aerated sucrose. The cohesive non-free flowing sweetener compositions have a mass of about 0.9 to about 1.3 grams. A granulated sugar cube of the same dimensions has a mass of about 1.4 grams.

### Example 7

Cohesive non-free flowing sweetener compositions of the present invention having the ingredients in Table 4 are produced using the laboratory scale method of Example 1.A.

TABLE 4
Composition and caloric burden of cohesive non-free flowing sweetener
compositions of the present invention.

| Formulation | Polydextrose | Tagatose | Erythritol | Trehalose | Maltodextrin | Maltose | Sucralose | KCal/ |
|---|---|---|---|---|---|---|---|---|
| Number | (% wt) | (% wt) | (% wt) | (% wt) | (% wt) | (% wt) | (% wt) | Cube |
| 1 | 9.9 | 26.6 | 10.9 | — | 7.7 | 45.0 | — | 3.67 |
| 2 | 9.9 | 26.6 | 10.9 | 45.0 | 7.7 | — | — | 3.67 |
| 3 | 5.4 | 24.3 | 25.8 | — | 13.1 | 31.5 | — | 3.15 |
| 4 | 5.4 | 24.3 | 25.8 | 31.5 | 13.1 | — | — | 3.15 |
| 5 | 8.2 | 28.9 | 36.7 | 26.3 | — | — | — | 2.29 |
| 6 | — | 36.8 | 10.8 | 15.0 | — | 37.0 | — | 3.74 |
| 7 | 9.6 | 33.0 | — | 15.0 | — | 42.0 | 0.4 | 4.04 |
| 8 | 10.0 | — | 29.5 | 15.0 | — | 45.1 | 0.4 | 3.61 |
| 9 | 10.0 | 37.5 | 28.4 | 11.2 | 2.5 | 10.0 | 0.4 | 2.36 |
| 10 | 9.9 | 26.6 | 10.9 | 35.0 | 7.7 | 10.0 | — | 3.67 |
| 11 | 9.9 | 26.6 | 10.9 | 30.0 | 7.7 | 15.0 | — | 3.67 |
| 12 | 9.9 | 26.6 | 10.9 | 25.0 | 7.7 | 20.0 | — | 3.67 |
| 13 | 9.9 | 26.6 | 10.9 | 20.0 | 7.7 | 25.0 | — | 3.67 |
| 14 | 9.9 | 26.6 | 10.9 | 15.0 | 7.7 | 30.0 | — | 3.67 |
| 15 | 9.9 | 26.6 | 10.9 | 10.0 | 7.7 | 35.0 | — | 3.67 |
| 16 | 10.0 | — | 37.5 | 40.7 | 11.8 | — | — | 3.18 |
| 17 | 10.0 | 68.0 | — | — | — | 21.5 | 0.5 | 2.80 |
| 18 | 8.2 | 28.9 | 36.7 | 15.0 | — | 10.7 | | 2.29 |
| 19 | 5.4 | 24.3 | 25.8 | 15.0 | 13.1 | 15.9 | 0.5 | 3.15 |
| 20 | — | 99.6 | — | — | — | — | 0.4 | 2.10 |
| 21 | 10.0 | — | 37.5 | 52.1 | — | — | 0.4 | 3.18 |
| 22 | — | 42.6 | — | 57.0 | — | — | 0.4 | 4.04 |
| 23 | — | 32.8 | 41.0 | 13.0 | — | 12.7 | 0.5 | 2.29 |
| 24 | — | 29.6 | 25.8 | 31.5 | 13.1 | — | — | 3.15 |
| 25 | 10.0 | 37.5 | 28.4 | 23.7 | — | — | 0.4 | 2.33 |
| 26 | 10.0 | — | 56.6 | 33.0 | — | — | 0.4 | 1.53 |

The cohesive non-free flowing sweetener compositions produced above are subjected to testing for various properties.

Sucrose has a white, highly crystalline appearance. It is desirable for a sweetener cube to have an appearance as close to a conventional sucrose cube as possible. The crystal appearance of each of the sweetener cubes was assessed against commercially available TUTTI FREE™ (Saint Louis Sucre, Paris, France) cubes containing about 1.4 grams of sucrose. The crystal appearance of the experimental cubes was assessed on a scale of 1 to 5 by a panel of 3 to 4 people familiar with the TUTTI FREE™ product. A score of 5 represents a sweetener cube with a crystal appearance that is virtually indistinguishable from that of the TUTTI FREE™ product and a score of 1 represents a sweetener cube that displays virtually no crystal characteristics whatsoever.

Table 5 shows crystal appearance at 0%, 50% and 75% relative humidity for various cube formulations. These relative humidities represent a control (0%), the typical relative humidity found in consumers' homes (50%), and maximum expected under normal conditions (75%).

TABLE 5
Crystal appearance at 0%, 50%, and 75% relative humidity.

| | Crystal Appearance | | |
|---|---|---|---|
| Formulation | 0% Relative | 50% Relative | 75% Relative |
| Number | Humidity | Humidity | Humidity |
| 1 | 2.0 | 2.5 | 2.5 |
| 2 | 3.5 | 3.0 | 3.0 |
| 3 | 3.5 | 2.5 | 4.0 |
| 4 | 4.0 | 4.0 | 4.0 |
| 5 | 4.0 | 4.0 | 4.0 |
| 6 | 4.0 | 4.0 | 4.0 |
| 7 | 3.5 | 2.0 | 4.0 |
| 8 | 3.5 | 2.0 | 4.0 |
| 9 | 3.5 | 3.5 | 3.5 |
| 10 | 2.5 | 2.5 | 3.0 |
| 11 | 3.0 | 2.5 | 2.5 |
| 12 | 3.0 | 2.5 | 3.5 |
| 13 | 2.0 | 2.0 | 2.5 |
| 14 | 4.0 | 3.0 | 3.5 |
| 15 | 3.5 | 2.0 | 2.5 |
| 16 | 2.5 | 2.0 | 3.0 |
| 17 | 4.0 | 4.0 | 4.0 |
| 18 | 4.0 | 4.0 | 4.0 |
| 19 | 3.5 | 3.5 | 3.5 |
| 20 | 3.0 | 3.0 | 3.0 |
| 21 | 3.5 | 3.5 | 3.5 |
| 22 | 3.0 | 3.0 | 3.0 |
| 23 | 3.5 | 3.5 | 3.5 |
| 24 | 3.5 | 3.5 | 3.5 |
| 25 | 3.5 | 3.5 | 3.0 |
| 26 | 4.0 | 4.0 | 3.5 |

A crystalline appearance below about 4 will not be acceptable to a consumer as a substitute for a conventional sucrose cube.

A conventional sucrose cube has a friability of less than about 5%. To determine the friability of the experimental sweetener cubes each cube is placed on a 1-millimeter mesh. The cube is then gently brushed with a 2-inch brush to remove any loose powder. The cube is weighed to four decimal places. The cube is placed in the drum of a Caleva friability tester (Caleva Process Solutions Ltd, Dorset, United Kingdom) and rotated for 10 revolutions. The cube is again placed on the mesh and gently brushed to remove any loose powder. The cube is then re-weighed to four decimal places. The change in mass is expressed as a percent weight lost for 10 revolutions.

Table 6 shows percent friability at 0%, 50% and 75% relative humidity for various cube formulations with ten revolutions.

TABLE 6
Percent friability at 0%, 50%, and 75% relative humidity.

| | Friability % | | |
|---|---|---|---|
| Formulation | 0% Relative | 50% Relative | 75% Relative |
| Number | Humidity | Humidity | Humidity |
| 1 | 16.72 | 11.76 | 0.46 |
| 2 | 32.31 | 3.66 | 0.19 |
| 3 | 10.16 | 27.15 | 0.14 |
| 4 | 5.62 | 5.24 | 11.87 |
| 5 | 12.61 | 9.61 | 0.26 |
| 6 | 10.74 | 8.43 | 0.07 |
| 7 | 16.00 | 51.6 | 0.29 |
| 8 | 12.67 | 13.2 | 0.21 |
| 9 | 1.90 | 7.75 | 0.18 |
| 10 | 3.30 | 4.26 | 0.26 |
| 11 | 3.67 | 6.55 | 24.0 |
| 12 | 3.17 | 8.38 | 11.0 |
| 13 | 3.86 | 7.43 | 36.0 |
| 14 | 4.38 | 2.45 | 31.0 |
| 15 | 2.63 | 8.64 | 24.0 |
| 16 | 3.51 | 17.49 | 53.0 |
| 17 | 3.90 | 2.52 | 0.45 |
| 18 | 9.33 | 8.43 | 0.07 |
| 19 | 4.62 | 6.31 | 0.11 |
| 20 | 3.19 | 3.32 | 1.21 |
| 21 | 9.84 | 4.55 | 0.21 |
| 22 | 3.85 | 8.50 | 2.10 |
| 23 | 6.27 | 12.50 | 4.78 |
| 24 | 2.33 | 2.90 | 0.32 |
| 25 | | 1.43 | 0.15 |
| 26 | 16.72 | 0.31 | 0.17 |

If the friability of the sweetener cube is greater than about 10% at a relative humidity of 50%, then the cubes will crumble significantly upon transport to and use by the consumer. The consumer will not accept the loss of shape and mass by sweetener cubes with a friability greater than about 10%.

The moisture content of each of the sweetener cubes is determined using a moisture meter (MX-50 or MD-50, A&D Engineering, Inc., Milpitas, Calif.). The moisture meter measures the percent weight lost by the sweetener cube upon complete drying based on the total weight of the sweetener cube. Table 7 shows moisture content at 0%, 50% and 75% relative humidity for various cube formulations.

TABLE 7
Moisture content at 0%, 50%, and 75% relative humidity.

| | Moisture Content (% (wt)) | | |
|---|---|---|---|
| Formulation | 0% Relative | 50% Relative | 75% Relative |
| Number | Humidity | Humidity | Humidity |
| 1 | 2.98 | 3.02 | 3.10 |
| 2 | 3.84 | 3.88 | 0.66 |
| 3 | 2.06 | 4.34 | 1.76 |
| 4 | 2.41 | 3.43 | 1.60 |
| 5 | 1.53 | 2.28 | 4.03 |
| 6 | 2.90 | 3.69 | 3.76 |
| 7 | 5.07 | 5.30 | 4.90 |
| 8 | 3.86 | 6.35 | 4.02 |
| 9 | 1.90 | 2.05 | 1.71 |
| 10 | 3.30 | 3.94 | 3.01 |
| 11 | 3.67 | 3.92 | 2.01 |
| 12 | 3.17 | 3.36 | 2.01 |
| 13 | 3.86 | 4.36 | 2.60 |
| 14 | 4.38 | 3.11 | 1.77 |
| 15 | 2.63 | 3.75 | 1.95 |
| 16 | 3.51 | 3.75 | 2.10 |
| 17 | 1.83 | 2.61 | 2.17 |
| 18 | 2.23 | 2.71 | 2.68 |
| 19 | 2.30 | 3.67 | 2.13 |
| 20 | 1.44 | 1.39 | 1.70 |
| 21 | 3.46 | 7.19 | 5.11 |
| 22 | 1.89 | 4.77 | 5.26 |
| 23 | 3.49 | 3.50 | 2.94 |
| 24 | 4.46 | 2.24 | 4.98 |
| 25 | 2.53 | 3.63 | 2.10 |
| 26 | 2.20 | 4.01 | 4.54 |

If the moisture content of the cube is greater than about 3%, then the cubes may become soft and friable, and may also adhere to each other. The consumer will not accept sweetener cubes with a moisture content greater than about 5% because they will be soft to handle, lack crunch on consumption, and will not be comparable to sucrose cubes that are familiar to consumers.

A conventional sucrose cube has a hardness of about 30,000 g and a rigidity of about 30,000 g/s. The hardness and rigidity for each of the experimental sweetener cubes is determined using a TA-XT2i Texture Analyzer (Stable Micro Systems Ltd., Surrey, England). The cube to be tested is placed horizontally on the testing platform of the analyzer, directly under a 1-inch diameter probe. The probe size ensures that compression occurs on flat edges to get an actual hardness value for the sweetener cube. The analyzer settings are as follows:

| | | |
|---|---|---|
| Test Speed: | 1 | mm/s |
| Rupture Test Distance: | 4 | mm |
| Distance: | 1 | mm |
| Force: | 100 | g |
| Time: | 5 | sec |
| Load Cell: | 50 | Kg |

Table 8 shows hardness at 0%, 50% and 75% relative humidity for various cube formulations.

TABLE 8
Hardness at 0%, 50%, and 75% relative humidity.

| | Hardness (g) | | |
|---|---|---|---|
| Formulation | 0% Relative | 50% Relative | 75% Relative |
| Number | Humidity | Humidity | Humidity |
| 1 | 1824 | 1255 | 99 |
| 2 | 1179 | 496 | 1476 |
| 3 | 1615 | 438 | 1360 |
| 4 | 953 | 684 | 1142 |
| 5 | 1270 | 2783 | 2888 |
| 6 | 1981 | 1500 | 6300 |
| 7 | 2318 | 2949 | 5715 |
| 8 | 2927 | 1916 | 4304 |
| 9 | 779 | 2067 | 84 |
| 10 | 589 | 4228 | 627 |
| 11 | 2460 | 2833 | 538 |
| 12 | 188 | 690 | 176 |
| 13 | 2666 | 2097 | 509 |
| 14 | 934 | 2756 | 234 |
| 15 | 2228 | 1131 | 1054 |
| 16 | 776 | 872 | 2200 |
| 17 | 1606 | 1656 | 319 |
| 18 | 661 | 770 | 28 |
| 19 | 1651 | 1322 | 145 |
| 20 | 3465 | 690 | 426 |
| 21 | 4036 | 782 | 240 |
| 22 | 4295 | 1211 | 210 |
| 23 | 2752 | 649 | 1248 |
| 24 | 840 | 2482 | 129 |
| 25 | 3566 | 3092 | 83 |
| 26 | 2376 | 2725 | 1135 |

If the hardness of the cube is less than about 5000 g, then the cubes will become friable and can be broken by manual pressure. The consumer will not accept sweetener cubes with a hardness greater than about 30000 g as these will dissolve too slowly in a beverage such as tea or coffee, i.e. much more slowly than a sucrose cube.

Table 9 shows rigidity at 0%, 50% and 75% relative humidity for various cube formulations.

TABLE 9
Rigidity at 0%, 50%, and 75% relative humidity.

| | Rigidity (g/s) | | |
|---|---|---|---|
| Formulation | 0% Relative | 50% Relative | 75% Relative |
| Number | Humidity | Humidity | Humidity |
| 1 | 1797 | 1980 | 46 |
| 2 | 1265 | 1266 | 1466 |
| 3 | 1577 | 1578 | 1341 |
| 4 | 953 | 954 | 1106 |
| 5 | 1245 | 1246 | 2845 |
| 6 | 1977 | 1978 | 6252 |
| 7 | 2301 | 2302 | 5620 |
| 8 | 3077 | 3078 | 4263 |
| 9 | 8 | 2032 | 78 |
| 10 | 623 | 4167 | 613 |
| 11 | 2432 | 2804 | 533 |
| 12 | 176 | 670 | 167 |
| 13 | 3392 | 2074 | 494 |
| 14 | 911 | 2717 | 222 |
| 15 | 2548 | 1103 | 1037 |
| 16 | 766 | 842 | 2179 |
| 17 | 2762 | 2828 | 544 |
| 18 | 656 | 781 | 16 |
| 19 | 1610 | 1304 | 136 |
| 20 | 3400 | 667 | 496 |
| 21 | 3974 | 762 | 233 |
| 22 | 4983 | 1262 | 197 |
| 23 | 2754 | 619 | 1704 |
| 24 | 828 | 2558 | 118 |
| 25 | 3566 | 3053 | 74 |
| 26 | 2337 | 2682 | 1135 |

If the rigidity of the cube is greater than about 10,000 g/s, then the cubes will become difficult to dissolve in liquid or crumble for use on foods. The consumer will not accept this slow dissolution of sweetener cubes with a rigidity greater than about 30,000 g/s.

Three to five panelists familiar with the TUTTI FREE™ (or reference cube) product determined the stickiness of each of the sweetener cubes. The panelists arrived at a value for the stickiness of the experimental sweetener cubes using the 0-5 scale of Table 10 by group discussion. On this scale, the TUTTI FREE™ product has a stickiness of 5.

TABLE 10
Stickiness assessment scale.

| | Stickiness | | | | | |
|---|---|---|---|---|---|---|
| Scale | 5 | 4 | 3 | 2 | 1 | 0 |
| Criteria | Cube; as | Cube; | Cube; tacky to | Cube; sticks | Cube; | Liquified. |
| | control. | slightly soft. | the touch. | to finger | adhesive | |
| | | | | when lifted. | and forms a | |
| | | | | | strand when | |
| | | | | | removed. | |

Table 11 shows stickiness at 0%, 50% and 75% relative humidity for various cube formulations.

TABLE 11
Stickiness at 0%, 50%, and 75% relative humidity.

| | Stickiness | | |
|---|---|---|---|
| Formulation | 0% Relative | 50% Relative | 75% Relative |
| Number | Humidity | Humidity | Humidity |
| 1 | 5 | 5 | 5 |
| 2 | 5 | 5 | 5 |
| 3 | 5 | 5 | 5 |
| 4 | 5 | 5 | 5 |
| 5 | 5 | 5 | 5 |
| 6 | 5 | 5 | 4 |
| 7 | 5 | 5 | 4 |
| 8 | 5 | 5 | 4 |
| 9 | 5 | 4.5 | 4 |
| 10 | 5 | 5 | 5 |
| 11 | 5 | 5 | 3 |
| 12 | 5 | 5 | 5 |
| 13 | 5 | 5 | 5 |
| 14 | 5 | 5 | 5 |
| 15 | 5 | 5 | 5 |
| 16 | 5 | 5 | 5 |
| 18 | 5 | 4 | 2 |
| 19 | 5 | 5 | 2 |
| 20 | 5 | 5 | 5 |
| 21 | 5 | 4 | |
| 22 | 5 | 5 | 5 |
| 23 | 5 | 5 | 5 |
| 24 | 5 | 5 | 2.5 |
| 25 | 5 | 05 | 3 |
| 26 | 5 | 5 | 4 |

Cohesive non-free flowing sweetener compositions that have a stickiness less than about 3.5 at 50% relative humidity will adhere to one other and to any surface that they contact. Such sweetener cubes will not be convenient for or useable by the consumer.

A conventional sucrose cube has a dissolution time in water of about 5 to 20 seconds depending on cube size and water temperature. To determine the dissolution time of each of the experimental sweetener cubes, a 2-liter flask is filled with about 1 liter of water and placed on a magnetic stirring plate with heating plate. A 400-millimeter stirbar is placed in the flask. The water is heated to the desired temperature and stirred at about 150 to 180 rpm. A sieve with 1- or 1.18-millimeter mesh is placed mesh up, submerged in the water inside the flask above the stirring plate. The mesh is marked with an indelible marker for precise location of the cube. Using tweezers, the sweetener cube to be tested is placed on the sieve using the indelible mark for precise placement. The time from submersion of the sweetener cube and to complete dissolution is measured. The time of dissolution is recorded for 5 sweetener cubes of the same composition. The dissolution time is the average of the five individual dissolution times.

Table 12 shows dissolution time at 21° C., 55° C., and 85° C. for various cube formulations. These temperatures represent the temperatures of hot beverages (85° C. or 55° C.) and room temperature (21° C.).

TABLE 12
Dissolution time at 21° C., 55° C., and 85° C.

| Formulation | Dissolution Time (s) | | |
|---|---|---|---|
| Number | 85° C. | 55° C. | 21° C. |
| 1 | 45 | 13 | 195 |
| 2 | 43 | 12 | 290 |
| 3 | 117 | 18 | 300 |
| 4 | 97 | 44 | 230 |
| 5 | 16 | 28 | 40 |
| 6 | 44 | 27 | 300 |
| 7 | 32 | 31 | 215 |
| 8 | 20 | 43 | 127 |
| 9 | 15 | 14 | 98 |
| 10 | 6 | 31 | 23 |
| 11 | 32 | 42 | 153 |
| 12 | 19 | 16 | 108 |
| 13 | 37 | 23 | 127 |
| 14 | 8 | 42 | 42 |
| 15 | 38 | 39 | 78 |
| 16 | 10 | 18 | 300 |
| 17 | 45 | 47 | 147 |
| 18 | 14 | 35 | 84 |
| 19 | 20 | 98 | 73 |
| 20 | 8 | 24 | 68 |
| 21 | 27 | 27 | 97 |
| 22 | 23 | 24 | 154 |
| 23 | 53 | 25 | 300 |
| 24 | 46 | 257 | 285 |
| 25 | 25 | 21 | 56 |
| 26 | 19 | 65 | 320 |

Cohesive non-free flowing sweetener compositions that have a dissolution time greater than about 60 seconds in a hot beverage (85° C.) will not dissolve quickly enough to satisfy a consumer.

### Example 8

Additional examples of sweetener cubes of the present invention having a mass of 1.4 grams have the ingredients shown in Table 13:

TABLE 13
Sweetener cube formulations.

| Ingredient (%(wt)) | | | | | | | | |
|---|---|---|---|---|---|---|---|---|
| Polydextrose | Tagatose | Erythritol | Trehalose | Maltodextrin | Maltose | Lactose | Sucralose | KCal/Cube |
| | 99.6 | | | | | | 0.4 | 2.09 |
| 10.0 | 37.5 | 28.4 | 11.2 | 2.5 | 10.0 | | 0.4 | 2.33 |
| | 32.8 | 41 | 13 | | 12.7 | | 0.5 | 2.24 |
| 10.0 | 37.5 | 28.4 | 23.7 | | | | 0.4 | 2.33 |
| 10.0 | 68.0 | | | | 21.5 | | 0.5 | 2.77 |
| 5.4 | 24.3 | 25.8 | 15.0 | 13.1 | 15.9 | | 0.5 | 3.12 |
| 10.0 | | 37.5 | 52.1 | | | | 0.4 | 3.16 |
| 9.6 | 33.0 | | 15.0 | | 42.0 | | 0.4 | 4.02 |
| 10.0 | | 29.5 | 15.0 | | 45.1 | | 0.4 | 3.59 |
| | 42.6 | | 57.0 | | | | 0.4 | 4.09 |
| 20.0 | 7.0 | | | | | 72.5 | 0.5 | 4.49 |
| 5.0 | 25.0 | | | | | 69.5 | 0.5 | 4.49 |
| | 3.0 | | | | | 96.5 | 0.5 | 5.47 |
| 20.0 | 37.0 | | | 20.0 | | 22.5 | 0.5 | 3.44 |
| 20.0 | | 22.0 | | | | 55.5 | 0.5 | 3.45 |
| | | 40.0 | | | | 59.5 | 0.5 | 3.44 |

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents. Unless otherwise defined, all technical and scientific terms used herein have the same meaning as commonly understood by one of ordinary skill in the art to which this invention pertains. All publications, patent applications, patents, and other references mentioned herein are incorporated reference in their entirety. In case of conflict, the present specification, including definitions, will control.

What is claimed is:

1. A cohesive non-free flowing sweetener composition comprising a sweetening amount of a high intensity sweetener and an effective amount of a low-density bulking agent, wherein a sweetener cube formed from the cohesive non-free flowing sweetener composition having the same dimensions and an equivalent sweetness of a conventional sucrose cube has a lower caloric burden compared to a conventional sucrose cube.

2. A cohesive non-free flowing sweetener composition according to claim 1, wherein the low-density bulking agent is selected from the group consisting of aerated sugars, aerated polyols, aerated complex carbohydrates, agglomerated sugars, agglomerated polyols, agglomerated complex carbohydrates, cellulose, inulin, gum arabic, soluble fibers, proteins, and combinations thereof.

3. A cohesive non-free flowing sweetener composition according to claim 2, wherein the low-density bulking agent is selected from the group consisting of agglomerated maltodextrin, honeycombed or aerated sugar, glassy aerated sugar, and combinations thereof.

4. A cohesive non-free flowing sweetener composition according to claim 1, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, thaumatin, salts, esters, and combinations thereof.

5. A cohesive non-free flowing sweetener composition according to claim 4, wherein the high intensity sweetener is sucralose.

6. A cohesive non-free flowing sweetener composition comprising about 0.6% sucralose and about 99.4% agglomerated maltodextrin by weight based on the total weight of the sweetener composition, wherein a sweetener cube formed from the cohesive non-free flowing sweetener composition having the same dimensions and an equivalent sweetness of a conventional sucrose cube has a lower caloric burden compared to a conventional sucrose cube.

7. A cohesive non-free flowing sweetener composition comprising about 0.6% sucralose and about 99.4% inulin by weight based on the total weight of the sweetener composition, wherein a sweetener cube formed from the cohesive non-free flowing sweetener composition having the same dimensions and an equivalent sweetness of a conventional sucrose cube has a lower caloric burden compared to a conventional sucrose cube.

8. A cohesive non-free flowing sweetener composition comprising about 0.4% sucralose and about 99.6% of honeycombed or aerated carbohydrate by weight based on the total weight of the sweetener composition, wherein a sweetener cube formed from the cohesive non-free flowing sweetener composition having the same dimensions and an equivalent sweetness of a conventional sucrose cube has a lower caloric burden compared to a conventional sucrose cube.

9. A cohesive non-free flowing sweetener composition of claim 8, wherein the honeycombed or aerated carbohydrate is selected from the group consisting of sucrose, glucose, tagatose, maltodextrin, erythritol, and combinations thereof.

10. A cohesive non-free flowing sweetener composition comprising about 0.4% sucralose and about 99.6% of glassy aerated carbohydrate by weight based on the total weight of the sweetener composition, wherein a sweetener cube formed from the cohesive non-free flowing sweetener composition having the same dimensions and an equivalent sweetness of a conventional sucrose cube has a lower caloric burden compared to a conventional sucrose cube.

11. A cohesive non-free flowing sweetener composition of claim 10, wherein the glassy aerated carbohydrate is selected from the group consisting of sucrose, glucose, tagatose, maltodextrin and combinations thereof

12. A method for making a cohesive non-free flowing sweetener composition comprising:
(a) combining a high intensity sweetener with a low-density bulking agent to form a blend;
(b) adding sufficient water to the blend;
(c) forming the blend from (b) into a shape; and
(d) drying the shape.

13. The method of claim 12, wherein the low-density bulking agent is selected from the group consisting of agglomerated maltodextrin, honeycombed or aerated sugar, glassy aerated sugar, and combinations thereof.

14. A sweetener cube composition made by the method of claim 12.
